(19) United States
(12) Patent Application Publication
(10) Pub. No.: US 2003/0161944 A1
(43) Pub. Date: Aug. 28, 2003

(54) Vacuum deposition of powdered phosphor

(75) Inventors: Randy A. Barksdale, Livermore, CA (US); Ronald B. Robinson, Modesto, CA (US); Sharon S. Alvarez, San Ramon, CA (US); Gary D. Power, Ripon, CA (US)

Correspondence Address: Alan H. Thompson, Assistant Laboratory Counsel, Lawrence Livermore National Laboratory, P.O. Box 808, L-703, Livermore, CA, 94551, US

(73) Assignee: The Regents of the University of California

(21) Appl. No.: 10/085,550

(22) Filed: Feb. 26, 2002

(51) Int. Cl. B05B 5/00; B05D 3/02; B05D 1/12

(52) U.S. Cl. 427/157; 427/180; 427/376.1

(57) ABSTRACT

A vacuum deposition process for depositing powdered phosphor on fiber optic face plates, such as the output fiber optic window of gated image intensifiers. The process involves resistive heating vacuum deposition of a powdered phosphor, such as Zn, CD, (S) to a thickness of 7900 Angstroms, for example, after which it is annealed which promotes a columnar growth and makes the phosphor efficient. The thus annealed phosphor can then be directly overcoated with aluminum of a thinner coating than over a powdered phosphor produced by prior known methods due to the smoother surface produced by this process.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

The present invention relates to powdered phosphor screens, particularly to a method for depositing powdered phosphor, and more particularly to a resistive heating vacuum deposition process for depositing powdered phosphor on fiber optic face plates, for example.

Powdered phosphor has been used as a cathodoluminescent material for many years. These powdered screens have been deposited in many different ways. Those in the art have used settling, spraying, and electrophoresis in their attempt to evenly deposit the powdered phosphor material. By way of example U.S. Pat. No. 4,415,605 uses a powder composed of C₅1; U.S. Pat. No. 4,437,001 discloses a process using a multi-layer deposition of C₅1; U.S. Pat. No. 4,528,210 uses a process involving a multi-layer technique; U.S. Pat. No. 4,803,400 involves using a paint like suspension of a phosphor powder; U.S. Pat. No. 4,950,948 involves a vacuum deposition process for phosphor powder; U.S. Pat. No. 5,180,610 uses a pressing method under heat, pressure, and vacuum; U.S. Pat. No. 3,852,132 involves a method of manufacturing x-ray image intensifier input phosphor screens; and U.S. Pat. No. 5,707,682 is directed to a method of manufacturing a phosphor screen.

Extensive development work has been carried out at the Lawrence Livermore National Laboratory (LLNL) using the spraying method because the fiber optic faceplates being developed were in some cases curved. The phosphor deposition process has always been more of a skill than a scientific process.

The vacuum deposition process of the present invention is a very controlled and scientific procedure with great improvements over the prior known processes. The process of this invention cuts three days off of the time it takes to produce an aluminum over coated fiber optic output phosphor window for a night vision tube, for example. The vacuum deposited phosphor has improved spatial resolution, is more robust and it is easier/cheaper to produce.

### SUMMARY OF THE INVENTION

It is an object of the present invention to provide an improved process for the deposition of powdered phosphor.

A further object of the invention is to provide a process for powdered phosphor deposition wherein the deposited phosphor is more uniform, more robust, and has a much higher spatial resolution than settled or brush phosphors.

A further object of the invention is to provide a vacuum deposition process for powdered phosphor.

Another object of the invention is to provide a vacuum deposition process to deposit powdered phosphor on the output fiber optic window of a gated image intensifier.

Another object of the invention is to provide a resistive heating vacuum deposition process to deposit powdered phosphor, wherein the powdered phosphor is heated and deposited under vacuum to a desired thickness, after which the deposited phosphor is annealed, and if desired overcoated with a thin metal coating.

Other objects and advantages of the present invention will become apparent from the following description. The invention involves a process for vacuum deposition of powdered phosphor. The powdered phosphor can be deposited on flat or curved surfaces, such as the output fiber optic window of a gated image intensifier. The thus deposited powdered phosphor screen is more uniform, more robust, and has much higher spatial resolution than settled or brushed phosphor screens. The process involves resistive heating vacuum deposition to deposit a powdered phosphor composed for example of Zn, CD, (S), commonly known as P20 phosphor manufactured by General Electric Co. The powdered phosphor is heated, deposited under vacuum conditions to a desired thickness, and then annealed which promotes columnar growth and makes the phosphor efficient. The surface of the annealed powdered phosphor is smooth, and if aluminum, for example, is deposited on the surface the coating can be thinner due to the smoother surface. The vacuum deposition process can be utilized for optic face plates for microchannel plate detectors, or night vision applications, or any image intensifier, as well as possible use in CRT manufacturing.

### DETAILED DESCRIPTION OF THE INVENTION

The invention involves a vacuum deposition process to deposit powdered phosphor, such as on the output fiber optic window of a gated image intensifier, or for a night vision tube. A thus produced phosphor screen is more uniform, more robust, and has a much higher spatial resolution than settled or brushed screens. The vacuum deposition produced by this invention is a very controlled and scientific procedure with great improvements over the prior known deposition techniques. This process cuts three days off of the time it takes to produce an aluminum over coated fiber optic output phosphor window for a night vision tube, for example. The vacuum deposited phosphor has improved spatial resolution is more robust, and it is easier/cheaper to produce.

The invention is a resistive heating vacuum deposition process, particularly applicable for depositing P-20 phosphor, made by General Electric Co., a Zn, CD, (S) powdered phosphor. The powdered phosphor is placed in a tantalum boat resistively heated to a temperature of 350° to 600° C., and deposited on a surface (fiber optic face plate) at a pressure of 1×10⁻⁶ Torr, but the vacuum pressure may vary from 1×10⁻⁴ to 1×10⁻⁷ Torr, the phosphor is deposited to a thickness of 7900 Angstroms for example, but the thickness can vary from 2,500 to 10,000 Angstroms. The phosphor is then annealed at 550° C. for 2 hours, but may be carried out at 400° to 600° C. for a 15 min. to 2 hours time period. This annealing process is what promotes the columnar growth and makes the phosphor efficient. The phosphor can then be directly overcoated with 400 to 1,000 Angstroms of aluminum, for example. The aluminum may be deposited by electron or magnetron sputtering. This process does not require a Lacquer layer between the phosphor and the aluminum. The aluminum can be coated much thinner (down to about 400 Angstroms) than a powdered phosphor due to the smoother surface caused by the annealing, the smoothness of the surface being in range of 10 nm to 30 nm. This thinner aluminum layer lowers the dead layer voltage, and the smoother overall screen allows the user to run the screen at a higher voltage or closer gap to a microchannel plate. Metals in addition to aluminum may be used, such as Au or Ag. The resistive heating process changes the response peak from green to orange, which is ideal for a CCD readout system. This process will allow the user to coat multiple samples at a time and greatly reduce the process time.

It has thus been shown that the present invention provides an effective process for depositing powdered phosphor, and the deposited phosphor is more uniform, more robust, and has a higher spatial resolution than can be produced by prior deposition techniques. The process results in a smooth phosphor surface wherein a metal coating, such as aluminum can be coated much thinner than on prior powdered phosphor deposits. The vacuum deposition process is controlled and reduces production time for aluminum overcoated fiber optic output phosphor windows for a night vision tube, for example. The process is easier and cheaper than prior known powdered phosphor deposition approaches.

While a specific example, along with specific materials, parameters, etc, have been set forth to exemplify and teach the principles of the invention, such is not intended to be limiting. Those skilled in the art may make modifications and changes, and it is intended that the invention be limited only by the scope of the appended claims.

What is claimed is:

1. In a process for depositing powdered phosphor on a surface, the improvement comprising:
using vacuum deposition to deposit the powdered phosphor.

2. The improvement of claim 1, wherein the vacuum deposition is carried out using heated powdered phosphor.

3. The improvement of claim 2, wherein the heated powdered phosphor is resistively heated to a temperature in the range of 350° to 600° C.

4. The improvement of claim 1, wherein the powdered phosphor is deposited to a thickness of 2,500 to 10,000 Angstroms.

5. The improvement of claim 1, wherein the vacuum deposition is carried out at a pressure of 1×10⁻⁴ to 1×10⁻⁷ Torr.

6. The improvement of claim 1, additionally including annealing the vacuum deposited powdered phosphor surface.

7. The improvement of claim 6, wherein the annealing is carried out at a temperature of 400° to 600° C. for a time period of 15 min. to 2 hours.

8. The improvement of claim 6, wherein the annealing is carried to so as to produce a phosphor surface having a smoothness in the range of 10 nm to 30 nm.

9. The improvement of claim 6, additionally including depositing a coating on the annealed phosphor surface selected from the group consisting of aluminum, gold and silver.

10. The improvement of claim 9, wherein the coating is aluminum deposited to a thickness of 400 to 1000 Angstroms.

11. The improvement of claim 1, additionally including providing the powdered phosphor having a composition consisting of Zn, CD, (S).

12. The improvement of claim 11, additionally including placing the powdered phosphor in a tantalum boat, and resistively heating the powdered phosphor.

13. A resistive heating vacuum deposition process to deposit powdered phosphor, comprising:
providing a quantity of powdered phosphor, placing the powdered phosphor in a tantalum boat,
resistively heating the powdered phosphor,
depositing by vacuum deposition the heated powdered phosphor on a surface, and
annealing the deposited powdered phosphor.

14. The process of claim 13, additionally including depositing a coating of a selected metal on the annealed phosphor surface.

15. The process of claim 13, additionally including supplying the quantity of powdered phosphor from a powdered phosphor comprising Zn, CD, (S).

16. The process of claim 13, wherein resistively heating the powdered phosphor is carried out in a temperature range of 350° to 600° C.

17. The process of claim 13, wherein the vacuum deposition is carried of at a pressure of 1×10^{-4 to} 1×10⁻⁷.

18. The process of claim 13, wherein the powdered phosphor is deposited to a thickness of 2,500 to 10,000 Angstroms.

19. The process of claim 13, wherein the annealing is carried out at a temperature of 400° to 600° C. for a time period of 15 min. to 2 hours.

20. The process of claim 13, wherein the annealing produced a phosphor surface having a smoothness in the range of 10 nm to 30 nm.

21. The process of claim 14, wherein the coating of a selected metal is composed of metals selected from the group consisting of aluminum, gold and silver.

22. The process of claim 21, wherein the selected metal is composed of aluminum with a thickness in the range of 400 to 1000 Angstroms.
